(19) United States
(12) Patent Application Publication
(10) Pub. No.: US 2003/0071174 A1
(43) Pub. Date: Apr. 17, 2003

(54) Holding means for an aeration system

(75) Inventors: Arnold Jager, Burgdorf (DE); Volker Edel, Isernhagen (DE)

Correspondence Address: ROBERT W. BECKER & ASSOCIATES, Suite B, 707 Highway 66 East, Tijeras, NM, 87059, US

(73) Assignee: Gummi-Jager KG GmbH & Cie, Hannover (DE)

(21) Appl. No.: 10/268,548

(22) Filed: Oct. 10, 2002

(30) Foreign Application Priority Data
Oct. 10, 2001 (DE) 101 49 854.3

(51) Int. Cl. F16L 3/08

(52) U.S. Cl. 248/74.3; 248/74.1

(57) ABSTRACT

A holder is provided for an aeration system for introducing air or gas into a liquid. The aeration elements of the system include an elongated support body on which is disposed a sleeve-like cover of elastomeric material that envelops a support body and is provided with a plurality of slits that open under the influence of compressed gas. At least one fastening element is provided and has a component that extends at least partially about the aeration element and rests against the upper edge thereof and is spaced from a central portion of the aeration element. The fastening element also has a guide element for securement to a base or carrier member. The guide element has a groove for receiving the lower edge of the aeration element.

### BACKGROUND OF THE INVENTION

The present invention relates to a holding means for an aeration system by means of which air or some other gas can be introduced into a liquid, whereby the aeration system includes one or more aeration elements, each of which has an elongated support body on which is disposed a sleeve-like cover of elastomeric material such as rubber or rubber-like polymeric material that closely envelops the support body and is provided with a plurality of slits that open under the influence of compressed air or gas, whereby the support body has a cross-sectional configuration with greatly differing side lengths, with the longer side of the cross-section being disposed essentially vertically.

German Patent application DE 100 55 785 discloses such an aeration system. With this aeration system, which strives to improve pressure losses as well as the size of the air bubbles, it is possible for the apparatus to have lengths of more than four meters. However, DE 100 55 785 does not suggest what means can be used to secure the aeration system in the vessel that is provided for accommodating the liquid that is to be gasified. Such fastening means are required not to prevent expansion of the hose nor a transport of gas within the diffuser or aerating system; the fastening means must also prevent the upright diffuser from tipping over. In addition, the fastening means should permit an easy assembly and disassembly of the diffuser.

It is therefore an object of the present invention to provide a holding means that meets these requirements.

### BRIEF DESCRIPTION OF THE DRAWINGS

This object, and other objects and advantages of the present invention, will appear more clearly from the following specification in conjunction with the accompanying schematic drawings, in which:

FIG. 1 is a cross-sectional view of one exemplary embodiment of an inventive fastening element;

FIG. 2 is a side view of an aeration system having fastening elements pursuant to FIG. 1;

FIG. 3 is a plan view of the aeration system of FIG. 2;

FIG. 4 is a cross-sectional view of a modified embodiment of an inventive fastening element;

FIG. 5 is a side view of an aeration system having fastening elements pursuant to FIG. 4; and

FIG. 6 is a plan view of the aeration system of FIG. 5.

### SUMMARY OF THE INVENTION

The object of the present invention is realized in that the holding means is provided with one or more fastening elements, wherein a fastening element is provided with at least one component that extends in an at least partially ring-like manner about the aeration element, wherein this component rests against an upper edge of the aeration element and is spaced from the central portion thereof, wherein the fastening element is further provided with a guide element that is adapted to be secured to a base or carrier member, wherein the guide element has a groove for receiving a lower edge of the aeration element; the component and the guide element cooperate with one another.

Thus, the aeration element is held only at its upper and lower ends, whereas in the middle it can freely expand under the influence of the compressed air or gas. The guide element can be an elongated component, which supports a longer portion of the aeration element, and it extends in an at least partially ring-like manner about the aeration element at several locations. However, the fastening elements can also be short, flat components that support the aeration element in only a point-like manner. With this embodiment, any desired disposition of the aeration element is possible, for example even a curved placement. With the inventive holding means, any number of aeration elements can be disposed at the base of the container or vessel that is to be filled with the liquid that is to be aerated, such a vessel being, by way of example, a clarification reservoir. However, the aeration elements can also be secured via the inventive holding means to frames, carriers or the like that are disposed in the vessel and that for the purpose of assembly or maintenance can be raised out of the liquid.

The component that extends about the aeration element in an at least partially ring-like manner can be formed by a clip or a clamp that is disposed on the guide element. Pursuant to one advantageous embodiment of the invention, such a clip is connected with the guide element by a clip or snap connection, thus enabling a particularly easy assembly and disassembly. In addition, the clip or clamp can be provided with a groove for guiding the upper edge or end of the aeration element.

Pursuant to another embodiment of the invention, the component that extends about the aeration element in an at least partially ring-like manner is a hose clip or a plastic band in the manner of a cable binder. Such an embodiment of the invention has the advantage that simple, conventional components can be utilized.

In a straightforward manner, the groove can be formed with linear walls and can have such a depth that it effects a guidance of the aeration element yet does not prevent the expansion of the sleeve nor bubbling of the air out of the sleeve. Relative to the aeration element, the groove has a slightly smaller dimension so that the aeration element can be held in the groove by a clamping action. Pursuant to another advantageous embodiment of the invention, the walls of the groove narrow in a direction away from the base thereof, and such a groove is used with an aeration element, the support body of which has a bead-shaped end that can be disposed in the groove, so that a positive or form-locking connection results between the aeration element and the guide element. The guide element can then be embodied as a clip or snap type profiled member.

The individual components of the inventive fastening element are preferably made of polymeric material, stainless steel, or some other chemically resistant material.

Further specific features of the present invention will be described in detail subsequently.

### DESCRIPTION OF PREFERRED EMBODIMENTS

Referring now to the drawings in detail, a diffuser or aeration element 1 is secured via a fastening element 2 to the base 3 of a container or vessel that serves for accommodating the liquid that is to be aerated or gasified. This vessel can, for example, be a reservoir of a clarification plant.

The aeration element 1 comprises a panel-like, elongated support body 4 that is enveloped in a tube or sleeve 5. The sleeve 5 is made of rubber or a rubber-like or other elastomeric material. Its wall is interrupted by a plurality, though here not illustrated, of slits through which the air can escape from the interior of the sleeve into the surrounding region. Such an aeration element is described in greater detail in DE 100 55 785. Due to the panel-like shape of the support body 4, the aeration element 1 has greatly differing side lengths. The longer sides 12 are disposed vertically. The narrow sides form the upper and lower edges 13, 14, at which the aeration element 1 is secured.

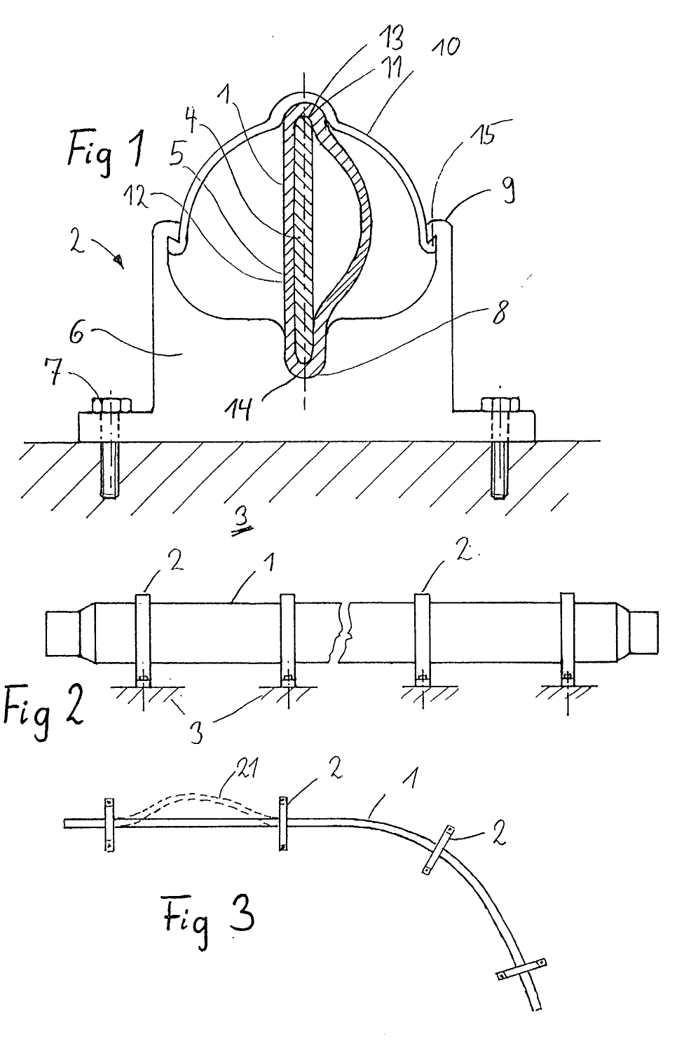

The fastening element 2 of FIG. 1 is provided with a lower portion in the form of a guide element 6. This guide element is a flat profiled member that can be made of metal, especially stainless steel, or a tough polymeric material. It is secured to the vessel base 3 via two screws or bolts 7. In the middle of that side that faces away from the base 3, the profiled member has a groove 8 into which is placed the edge or lower end 14 of the aeration element 1. In this connection, the width of the aeration element 1, in the non-mounted state, is slightly greater than the width of the groove 8, so that in the mounted state the aeration element 1 is seated in the groove via an elastic clamping. Proceeding from the groove, the wall of the profiled member extends upwardly in an approximately semicircular manner, and ends in hook-like projections 9.

The upper portion of the aeration element 1 is formed by an approximately semicircular shaped bracket or clamp 10, which can also be made of metal or a tough polymeric material. The clamp 10 overlaps the aeration element 1, so that the latter is completely embraced by the two portions 6, 10 of the fastening element 2. Formed in the top portion of the clamp 10 is a groove 11 in which is guided the edge or upper end 13 of the aeration element 1.

The ends of the clamp 10 are provided with hook-type projections 15 that catch behind the projections 9 of the guide element 6 and thus form a positive or form-locking connection between the upper and lower portions 6 and 10 of the fastening element 2 and the aeration element 1, whereby the individual components mutually support one another with elastic force. Assembly and disassembly can be effected in a straightforward manner by means of a slight elastic pressing together of the clamp for the catching of the hook-type projections. Thus, with the inventive fastening element 1 the securement thereof can be effected by the following steps: 1) screwing the guide element 6 tightly to the vessel base 3, 2) placing the aeration element 1 into the groove 8 of the guide element 6, possibly with a slight pressure, and 3) catching of the parts of the clamp 10.

As a consequence of the inventive fastening element 2, the aeration element 1 is held merely at the outer edges, while it is free in the middle. The aeration slits in the sleeve 5 need be provided merely in the central zone of the sleeve. In FIG. 1, the left half of the drawing serves to illustrate the aeration element in a non-pressurized state of rest, while the right half of the drawing serves to show the state where the aeration element is pressurized. In the non-pressurized state, the sleeve 5 rests flat against the support body 4 due to the inherent force of the sleeve as well as due to the ambient pressure. If the sleeve is pressurized, it inflates in a balloon-like manner, and the aeration slits open. The inventive fastening element 2 does not hinder this inflation or expansion.

FIG. 2 illustrates how an aeration element 1 can be secured by a plurality of inventive fastening elements 2. The fastening elements enable a flexible adaptation to the actual conditions. The aeration elements 1 can be provided individually or a plurality of such elements can be provided, for example parallel at the vessel base or in a frame or rack in the vessel; a curved disposition is also possible, as illustrated in FIG. 3. Due to the point-type securement, compensation movements of the aeration element 1 are possible when there is flow in the liquid, as indicated by dashed lines in FIG. 3 at the reference numeral 21.

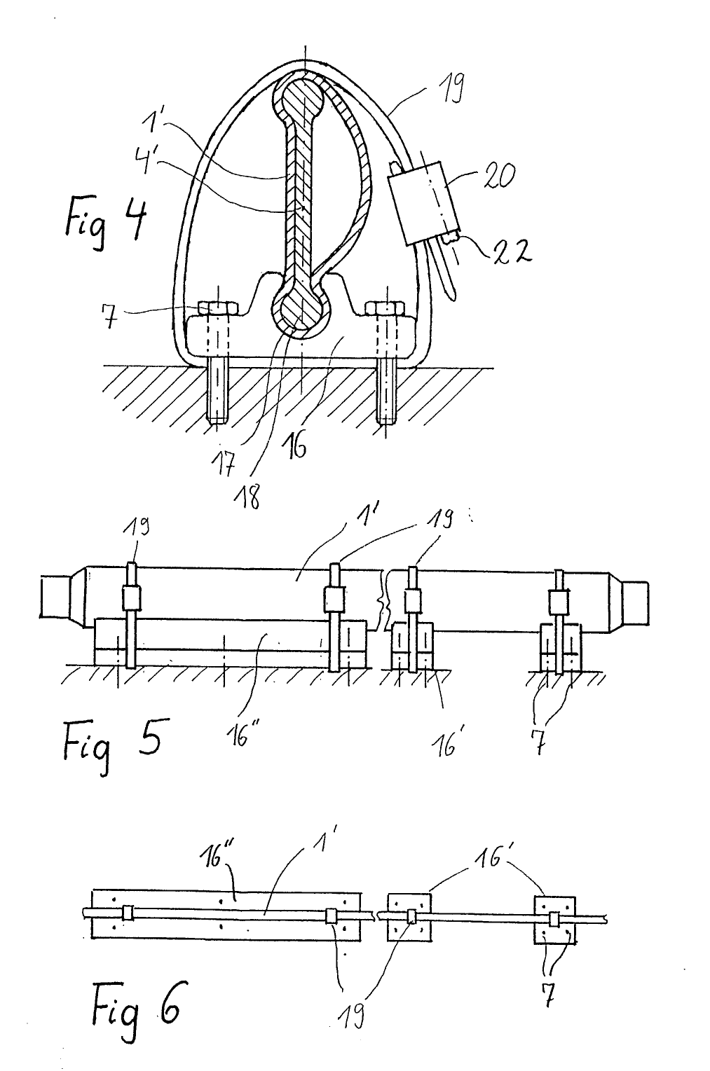

FIGS. 4 to 6 show another embodiment of the invention, whereby in the following only those features will be described in greater detail that in this embodiment differ from the embodiment of FIGS. 1 to 3. The differences are directed on the one hand to the profiled guide member and on the other hand to the components that surround the aeration element.

The guide element is a profiled member 16 that has a groove 17 into which is placed the lower end 18 of the aeration element 1′. The edges of the support body 4′, and hence also the rim or end 18 of the aeration element 1′, are a bead-like widened portion. In conformity with the shape of the bead of the end 18, the groove 19 narrows in a direction away from the end. The guide element 16 and the aeration element 1′ can therefore be connected with one another in a positive or form-locking manner. If the guide element 16 is made of an elastically deformable material, such as a polymeric material, the aeration element 1′ can be inserted from above into the groove by means of a light pressure (a catch or snap profile).

FIGS. 5 and 6 show two different embodiments of the guide element 16. The right half of both FIGS. 5 and 6 shows short guide elements 16′ that support the aeration element in an essentially point-type manner, with their disposition being similar to that described in conjunction with FIG. 3. The left half of both FIGS. 5 and 6 illustrates an elongated guide element 16″ that guides the lower edge of an aeration element 1′ along a longer section.

The component that extends about the upper portion of the aeration element 1′ is a hose clip 19. This can be a conventional hose clip that is provided with a clasp or fastener 20 that can be tightened by means of a screw 22. The clip 19 is guided about the outside not only of the aeration element 1′ but also of the guide element 16. To prevent sliding of the clip in the longitudinal direction of the aeration element 1′, the guide elements 16 can be secured to the base of the vessel or to a carrying frame via four screws 7 between which the clip is disposed. Such an arrangement of the screws 7, which is particularly advantageous for short guide elements 16′, is schematically indicated in FIGS. 5 and 6, where the screws 7 are indicated by dot-dash lines or dots.

Short guide elements 16′ can be provided with a single hose clip 19, as shown in the right half of both FIGS. 5 and 6. For long guide elements 16″, two or more hose clips 19 can be distributed over the length of the guide element.

In contrast to the clamp 10 described in conjunction with FIG. 1, the clip 19 of FIG. 4 has the advantage that it is simpler. Conventional components can be used. In the most straightforward configuration, instead of a hose clip it is even possible to use a flat band, similar to a cable binder. Such simple elements are advantageously used together with profiled guide member 16 of the type illustrated in FIG. 4 since with such profiled members the aeration element is held just by the groove 17.

The specification incorporates by reference the disclosure of German priority document DE 101 49 854.3 filed Oct. 10, 2001.

The present invention is, of course, in no way restricted to the specific disclosure of the specification and drawings, but also encompasses any modifications within the scope of the appended claims.

What we claim is:

1. A holding means for an aeration system for introducing air or other gases into a liquid, wherein said aeration system includes at least one aeration element, wherein each aeration element has an elongated support body on which is disposed a sleeve-like cover of elastomeric material that closely envelops said support body and is provided with a plurality of slits that open under the influence of compressed gas, wherein said support body has a cross-sectional configuration with greatly differing side lengths, and wherein longer ones of the sides are adapted to be disposed essentially vertically, said holding means comprising:
at least one fastening element, wherein each fastening element is provided with at least one component that extends in an at least partially ring-like manner about said aeration element, wherein said at least one component rests against an upper edge of said aeration element and is spaced from a central portion of said aeration element, wherein each fastening element is further provided with a guide element that is adapted to be secured to a base or carrier member, wherein said guide element has a groove for receiving a lower edge of said aeration element, and wherein said at least one component and said guide element cooperate with one another.

2. A holding means according to claim 1, wherein said at least one fastening element is a clip or clamp that at a bottom region of which is connected with said guide element and in an upper region is guided over said upper edge of said aeration element, and wherein an inner side of said guide element rests against said upper edge of said aeration element.

3. A holding means according to claim 2, wherein said clip or clamp is provided with a groove for receiving said upper edge of said aeration element.

4. A holding means according to claim 1, wherein said groove of said guide element has a width that is less than a width of said aeration element.

5. A holding means according to claim 2, wherein at least one of said clamp and said guide element is elastically deformable, and wherein said clamp and said guide element are interconnected in a positive manner via a clip connection.

6. A holding means according to claim 1, wherein ends of said support body are provided with widened portions, and wherein said groove of said guide element narrows in a direction away from a base thereof for receiving a widened end of said support body of said aeration element.

7. A holding means according to claim 6, wherein said guide element is a profiled clip member, and wherein said widened end of said aeration element is insertable into said groove of said guide element accompanied by elastic deformation of walls of said groove.

8. A holding means according to claim 1, wherein said at least one component that extends at least partially about said aeration element is a clip or a band that is provided with an adjustable fastener means that serves for increasing tension in said clip or band.

9. A holding means according to claim 8, wherein said clip or band extends about both said aeration element and said guide element.

10. A holding means according to claim 8, wherein said clip or band is a hose clip or a cable binder.

11. A holding means according to claim 1, wherein at least two short fastening elements are provided.

12. A holding means according to claim 1, wherein said at least one fastening element is provided with an elongated guide element on which are disposed at least two of said components that extend at least partially about said aeration element.

13. A holding means according to claim 8, wherein said guide element is secured to a base or carrier member by means of four securing elements, and wherein said clip or said band is disposed between said securing elements.
